(19) United States
(12) Patent Application Publication
(10) Pub. No.: US 2016/0352088 A1
(43) Pub. Date: Dec. 1, 2016

(54) SINGLE PLATE ARRESTER MOUNTING BRACKET

(71) Applicant: Prabhat K. Jain, Roanoke, VA (US)

(72) Inventor: Prabhat K. Jain, Roanoke, VA (US)

(73) Assignee: VIRGINIA TRANSFORMER CORPORATION, Roanoke, VA (US)

(21) Appl. No.: 14/721,303

(22) Filed: May 26, 2015

(51) Int. Cl. H02G 13/00; F16M 13/02

(52) U.S. Cl. CPC H02G 13/80; F16M 13/02

(57) ABSTRACT

A surge arrester mounting bracket may be provided. A surge arrester mounting bracket may include a plate having an arrester mounting section, a transformer mounting section, and at least one bend disposed therein. A surge arrester mounting bracket may further include at least one support gusset configured to engage and reinforce the plate.

### BACKGROUND

Surge arresters are devices that may help prevent damage to an apparatus due to high voltage surges. Arresters may provide a low-impedance path to ground for the current from a lightning strike or transient voltage and may restore to normal operating conditions. A surge arrester may be compared to a relief valve on a boiler or hot water heater, which may release high pressure until a normal operating condition is reached. When pressure has returned to normal, a safety valve may be ready for the next operation. Similarly, when a high, or greater than normal line voltage, exists on a line, an arrester may immediately furnish a path to ground and thus limit and drain off any excess voltage.

To mount arresters on a transformer tank, it traditionally requires a mounting post to brace them rigidly and securedly to the transformer with desired clearance. To accommodate desired orientations, existing arrester mounts typically include numerous parts affixed together, which may increase manufacturing costs. It may be desired for an arrester mount to provide physical support for a single or multiple surge arresters, to be easy to manufacture, to be easy to install, to require low labor to produce and install, and to require low material costs.

### SUMMARY

According to an exemplary embodiment, a surge arrester mounting bracket may be provided. A surge arrester mounting bracket may include a plate having an arrester mounting section, a transformer mounting section, and at least one bend disposed therein. A surge arrester mounting bracket may further include at least one support gusset configured to engage and reinforce the plate.

According to another exemplary embodiment, an adjustable surge arrester mounting bracket may be provided. An adjustable surge arrester mounting bracket may include a solid plate configured to be bent to achieve a desired height and length. The adjustable surge arrester mounting bracket may further include at least one gusset configured to reinforce a bent orientation of the solid plate.

### BRIEF DESCRIPTION OF THE DRAWINGS

Advantages of embodiments of the present invention will be apparent from the following detailed description of the exemplary embodiments. The following detailed description should be considered in conjunction with the accompanying FIGURE in which:

FIG. 1 shows a perspective view of an exemplary embodiment of a surge arrester mounting bracket.

### DETAILED DESCRIPTION

Aspects of the present invention are disclosed in the following description and related FIGURE directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

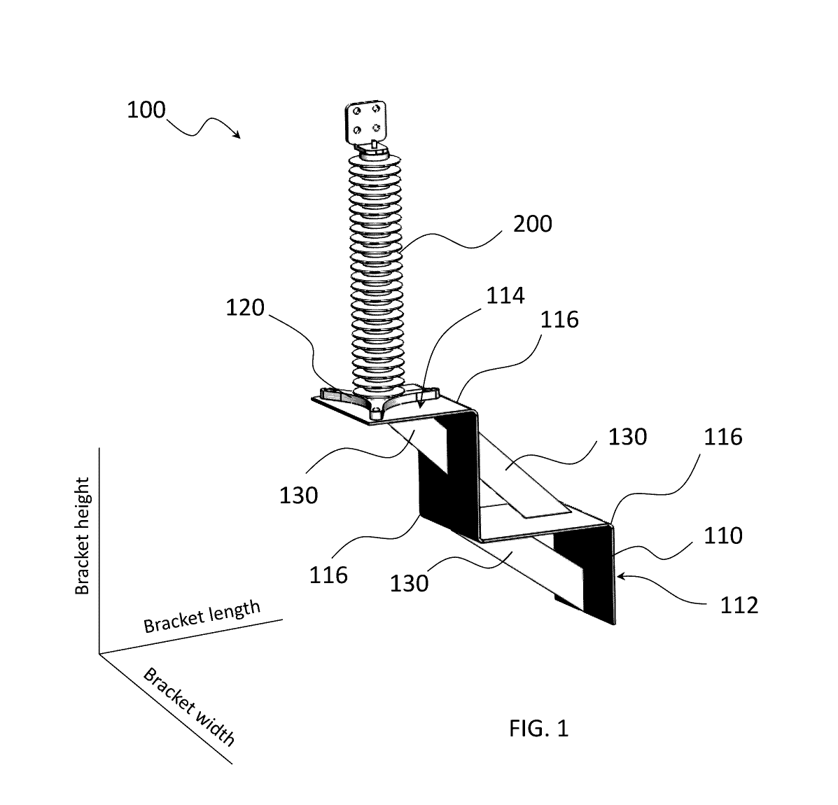

According to an exemplary embodiment, a surge arrester mounting bracket 100 may be provided. A surge arrester mounting bracket 100 may include a plate 110. In an exemplary embodiment, plate 110 may be a solid piece of metal, such as steel. Plate 110 may be a malleable material. In other exemplary embodiments, plate 110 may include a variety of materials. Plate 110 may vary in size and shape based on customer requirements, industrial standards, and/or the size and shape of the surge arrester 200 to be mounted on mounting bracket 100. Plate 110 may further be sized and shaped to accommodate the diameter of an arrester fastener 120. In an exemplary embodiment, arrester fastener 120 may include an arrester mounting bolt. Plate 110 may be of sufficient width, as defined in FIG. 1, to accommodate arrester fastener 120.

Referring to exemplary FIG. 1, plate 110 may be a solid piece of material, which may be manipulated, or bent, to achieve desired size and shape characteristics for mounting a particular arrester. For example, the height and length, as defined in FIG. 1, may be adjusted by changing the location of at least one sequential bend 116 in plate 110. Bends 116 may form a series of segments in plate 110. In some exemplary embodiments, the height and length of plate 110 may be set during manufacturing of bracket 100. In other exemplary embodiments, bends may be added, adjusted, or removed after manufacturing in order to adjust a bracket 100.

To reinforce plate 110 and ensure it maintains a desired mounting orientation for an arrester, additional supports or gussets 130 may be provided. Gussets 130 may enhance the strength of an arrester mounting bracket 100. Support gussets 130 may maintain the relational orientation of the segments created by the at least one bend 116. In some exemplary embodiments, gussets 130 may be formed from scrap material, reducing a need for specialized parts. This may reduce inventory requirements and material and labor costs. Plate 110 may include a transformer mounting section 112, which may be affixed to a transformer tank base to mount the mounting bracket 100. Transformer mounting section 112 may be welded to the transformer tank base or may include at least one mounting hole to accommodate at least one fastener or mounting stud for securing to the transformer tank base. An exemplary fastener may include a bolt, screw, nail, adhesive, or other similar fastener as would be understood by a person having ordinary skill in the art. Plate 110 may also include an arrester mounting section 114, which may accommodate arrester fastener 120. Arrester mounting section 114 may be welded or otherwise fastened to the arrester fastener 120, using similar fasteners to those described above.

The foregoing description and accompanying FIGURE illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A surge arrester mounting bracket comprising:
a plate having an arrester mounting section, a transformer mounting section, and at least one bend disposed therein; and
at least one support gusset configured to engage and reinforce the orientation of the plate.

2. The surge arrester mounting bracket of claim 1, wherein the at least one bend is positioned to achieve a desired bracket height and bracket length.

3. The surge arrester mounting bracket of claim 2, further comprising a series of bends positioned to achieve a desired bracket height and bracket length.

4. The surge arrester mounting bracket of claim 1, wherein the plate is solid.

5. The surge arrester mounting bracket of claim 1, wherein the plate is metal.

6. The surge arrester mounting bracket of claim 1, wherein the at least one gusset is secured to the plate on both sides of one of the at least one bends to secure the bend.

7. The surge arrester mounting bracket of claim 6, wherein the at least one gusset is secured to the plate by welding.

8. An adjustable surge arrester mounting bracket comprising:
a solid plate configured to be bent to achieve a desired height and length; and
at least one gusset configured to reinforce a bent orientation of the solid plate.

9. The adjustable surge arrester mounting bracket of claim 8, wherein the adjustable surge arrester mounting bracket has a width to accommodate an arrester mounting bolt.

10. The adjustable surge arrester mounting bracket of claim 8, further comprising at least one bend to achieve a desired height and length.

11. The adjustable surge arrester mounting bracket of claim 8, wherein the plate and at least one gusset are metal.

12. The adjustable surge arrester mounting bracket of claim 8, further comprising an arrester mounting section and a transformer mounting section, wherein the arrester mounting section and transformer mounting section are configured to be secured to an arrester and transformer, respectively.

13. The adjustable surge arrester mounting bracket of claim 8, wherein there is at least one gusset for each bend.

14. The adjustable surge arrester mounting bracket of claim 8, wherein the at least one gusset is welded to the plate.
